(19) United States
(12) Patent Application Publication
(10) Pub. No.: US 2015/0181323 A1
(43) Pub. Date: Jun. 25, 2015

(54) FLOATING CARRIER ASSEMBLY

(71) Applicant: GN Store Nord A/S, Ballerup (DK)

(72) Inventor: Flemming Juul RAKLEV, Koge (DK)

(21) Appl. No.: 14/574,949

(22) Filed: Dec. 18, 2014

(30) Foreign Application Priority Data
Dec. 20, 2013 (EP) 13198973.3

(51) Int. Cl. H04R 1/10; H04R 31/00

(52) U.S. Cl. CPC H04R 1/10; H04R 31/00

(57) ABSTRACT

A headset comprising one or two sound generators and a central portion for biasing the sound generator(s) toward the users head. A carrier assembly comprises electrical circuits and is fixed to the central portion at a single position, so that twisting of the central portion does not automatically lead to a similar twisting of the carrier assembly, whereby twisting will not lead to dismounting of the circuits on the carrier assembly.

The present invention relates to a headset with circuitry on a floating carrier assembly on which electrical circuits are present. The floating carrier assembly enables deformation, such as twisting of the headset without destroying the electrical circuits.

In a first aspect, the invention relates to a headset comprising:
an elongate central element having a longitudinal axis and two end portions,
one or two sound emitter portions each attached at an end portion of the central element,
a carrier assembly comprising one or more electric circuits and fastened to the central element at a single position thereof.

In the present context, a headset is an element for providing sound to a person and which has an elongate, central element for positioning on or around the person's head in order to position the sound emitter(s) at the ear(s) of the person. Naturally, further elements may be provided for positioning the sound emitter(s) at/on the person's ear(s) or maintaining this position, such as elements for resting on, behind or within the ear(s) of the person.

Headsets exist having elongate, central elements designed not for resting on the person's head but behind the back of the head, where other elements are provided at the sound generators for resting over the ears of the person for maintaining the sound generators in place, such as by biasing the sound generators/end portions toward the persons head/ears.

One or two sound emitters may be used. A headset may have two sound emitters, such as for generating stereo sound to the user or for, in addition to providing sound, reducing or attenuating ambient sound, for example. A single sound emitter may be used in situations where the user wishes to allocate one ear to ambient sound, such as for use in traffic, in office spaces, reception areas or the like.

In this context, an elongate central element is an element, normally curved, bent, twisted or arch-shaped, intended to fit over or around at least a part of the persons head. The curve may be a part of a circle or an oval and/or may have a soft shape or a sharply bending shape with one or more abrupt changes if desired, such as if forming part of a parallelogram. In many circumstances, the elongate central element extends from around one ear of the person to the other ear of the person. The elongate element is fastened to at least one sound generator and may at another end be fixed to another sound generator or a cushioning or the like making the wearing of the headset pleasant.

The end portions of the elongate central portion are normally the parts thereof which are the farthest from each other, such as in its rest position and/or when the elongate central portion is in a straight or linear configuration.

A sound emitter may comprise one or more sound generators, such as loudspeakers. Usually, a single loudspeaker is used for generating the sound for the ear, but multiple loudspeakers may be used for obtaining a better sound.

The carrier assembly is an element comprising one or more electric circuits. In this context, an electric circuit may be an ASIC, a processor, an FPGA or the like. However, also very simple electronic circuits as antennas, amplifiers, rectifiers, resistors, capacitors, inductors or the like are seen as electric circuits.

The carrier assembly may comprise an element, such as a printed circuit board, on which the circuits are provided or fastened. This element may have thereon or therein one or more conductive elements, such as conductive surface parts, to which the circuits are connected in order to transmit power/signals between each other.

The carrier assembly is fastened to the central element at a single position thereof. Preferably, the fastening allows rotation of the carrier assembly in relation to the central element. This may be obtained when the fastening is at or along a limited distance, such as less than 1 cm, such as less than 5 mm, such as at less than 2 mm of the carrier assembly. Apart from the fastening at the single position, the carrier assembly may move, such as rotate, in relation to the central element. This rotation may be limited by other elements as will be described further below.

In one situation, as is mentioned above, the central element is arched in a rest position.

In one embodiment, the carrier assembly has one or more wide portions divided or interconnected by one or more neck portions. These portions may be provided in the above-mentioned element holding the circuits or may be provided in all parts of the carrier assembly. The advantage of the neck portions is that any twisting of the carrier assembly along a direction or axis intersecting the neck portions may then primarily take place at or in the neck portions and not in the wide portions. Then, the circuits may be positioned in the wide portions in order for these to not be affected during bending/twisting.

In this situation, the wide portions preferably have (perpendicular to the above direction intersecting the neck portions) a width being at least 2 times, such as at least 2.5 times, such as at least 3 times, such as at least 4 times, such as at least 5 times, such as at least 6 times, such as at least 7 times, such as at least 8 times that of the neck portions. Naturally, the neck portions may comprise electrical conductors, as these are not as prone to malfunctioning during or due to bending as electrical circuits having multiple points of contact to the element.

In one situation, a first extreme wide portion is positioned closer to one end portion and another side portion closer to another end portion in order for the direction intersecting the neck portions to be along a longitudinal axis of the central element. When the central element is twisted, such as by fixing one end portion and rotating the other, the twisting of the carrier assembly will be at least substantially around the direction, whereby the above function of the neck portions may take place.

In one embodiment, the headset further comprises a sensor or detector connected to one or more of the one or more electric circuits. This sensor may be an electrical circuit and be positioned on or fastened to the carrier assembly. Alternatively, the sensor/detector may be fastened to e.g. the central element and electrically connected to one or more of the circuits of the carrier assembly. This sensor/detector may be an antenna for transmitting information to external elements, such as a mobile telephone. This may take place via Bluetooth, WiFi, NFC or the like.

Alternatively or additionally, the detector/sensor may receive information from the surroundings, such as a mobile telephone, WiFi transponders, satellites or the like. Thus, the detector/sensor may be a Bluetooth Antenna, a GPS antenna, a WiFi antenna, a magnetic sensor, an inertial sensor or the like. Naturally, the sensor/detector may also be used for detecting or sensing parameters of the user or the surroundings, such as temperature, direction of travel or speed.

In one embodiment, the headset further comprises a protecting element attached to the central element, the protecting element and the central element defining there between a space wherein the carrier assembly is positioned, the protecting element being deformable by twisting the central element around a longitudinal axis thereof. Preferably, the protecting element defines a space having a predetermined minimum height between the protecting element and the central element, and preferably, this height is maintained also during twisting. In a particularly interesting embodiment, the protecting element extends at least parallel to the central element and along a part of a length thereof. Twisting the central element around an axis positioned inside the central element will also twist the protecting element. Preferably, the protecting element is configured to allow and tolerate such twisting while maintaining the minimum height for the carrier assembly.

In one embodiment, the carrier assembly comprises a bendable element to which the one or more electric circuits are fastened and a carrier component. The carrier component may be an element which is stiffer than the bendable element. The carrier component may be fastened to the central element, and the bendable element may be fastened of fixed to the carrier component. This bendable element may be the above element which may be a PCB. In this embodiment, the bendable element is bent to form a U-shape. A part of the carrier component may be positioned inside the U-shape.

In that embodiment, an antenna may be provided in or on the bendable element, the antenna being positioned on/in a first part of the bendable element forming a first leg of the U-shape and the bendable element comprising, on or in a second part forming a second leg of the U-shape, a conductor forming a ground plane for the antenna. Alternatively, the ground plane may be provided on the above-mentioned carrier component. In that situation, the bendable element need not obtain the U-shape.

In that manner an antenna may be provided as conductors on e.g. a bendable PCB.

A second aspect of the invention relates to a method of manufacturing a headset, the method comprising:
providing an elongate central element having a longitudinal axis and two end portions,
attaching each of one or two sound emitter portions to an end portion of the central element,
fastening a carrier assembly comprising one or more electric circuits to the central element at a single position thereof.

Naturally, the individual elements may be as those described in relation to the first aspect of the invention. Also, it is clear that the steps required to manufacture the individual embodiments described above may also be added to the present aspect, such as the providing of a bendable element and bending it to form the U-shape described.

In the following, preferred embodiments will be described with reference to the drawing, wherein:

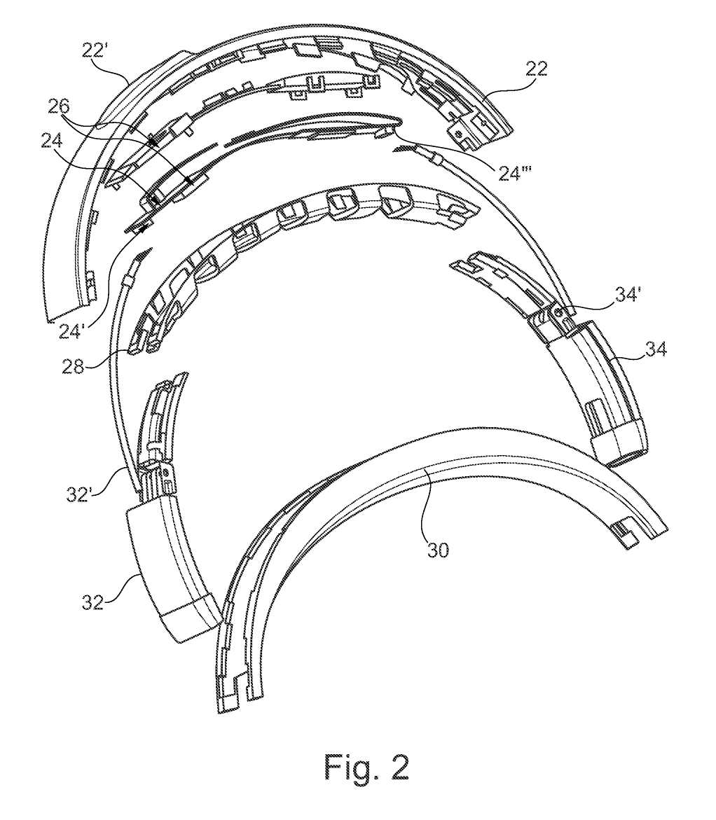

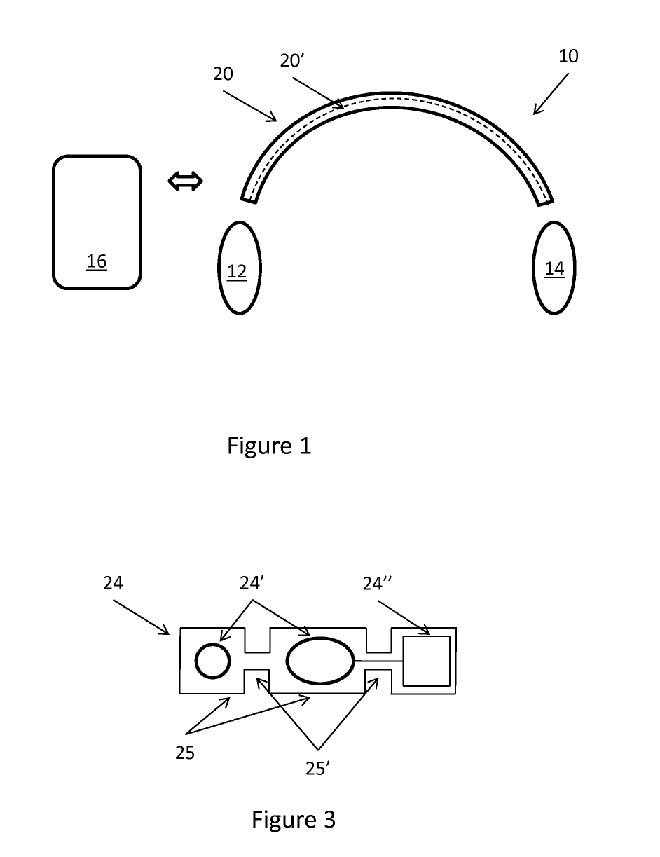

FIG. 1 is an illustration of a headset according to a first embodiment of the invention,

FIG. 2 is an exploded view of the headband for the headset of FIG. 1, and

FIG. 3 is an illustration of a preferred shape of a carrier assembly for use in the headband of FIG. 2.

In FIG. 1, a headset 10 is illustrated having a headband 20 and two sound generators 12 and 14. Often, the headset 10 is in communication with a communication device 16, such as a mobile telephone, media centre, media provider, computer or the like. This communication may be wired or wireless.

Usually signals, such as audio signals, are received by the headset 10 and fed to the user, subsequent processing is performed in the headset 10, and fed to the sound generators.

Also, signals may be generated in the headset 10, such as from a microphone and/or one or more sensors or detectors, such as antennas (see below), which may be used in signal processing in the headset 10 or may be fed to the communication device 16 if desired.

In FIG. 2, an exploded view of the headband 20 is seen. This headband 20 comprises a central part 22, which provides the overall strength and flexibility/rigidity required to maintain the headset in place on the head of a person.

In order to adapt to different head sizes, outer portions of the central part 22 are translatable in relation to external parts 32 and 34 to which the sound generators 12 and 14 are attached, usually in a rotational manner. Rotatable joints, 32′ and 34′, may be provided in order to allow the headset to obtain a collapsed position, if desired.

A cushioning 30 is provided between the central part 22 and the persons head. Between the cushioning 30 and the central part 22, a space is provided within which a carrier assembly 26 is positioned. The carrier assembly 26 holds one or more electric circuits 24′ and is fixed to the central part 22 at a single position in order to be movable, usually by rotation, in relation the central part.

In this embodiment, the carrier assembly 26 comprises a bendable element 24, such as a flex print, onto which the circuits 24′ are attached. Alternatively, the carrier assembly 26 itself may be a printed circuit board sufficiently stiff to carry out the carrying function without excessive bending which may dismount the circuits 24′.

A protective element 28 is provided between the carrier assembly 26 and the cushioning 30 primarily to prevent destruction of the carrier assembly 26 or circuits 24′ by external forces applied through the cushioning 30. The protective element 28 is attached, via a clicking action, to the central part 22, and the carrier assembly 26 is provided in a space between the protective element 28 and the central part 22.

During normal use of a headset 10, this will be expanded by pulling the sound generators 12 and 14 away from each other as well as twisted around the longitudinal axis 20′ by e.g. pulling one sound generator 14 out of the plane of the figure while forcing the sound generator 12 in the opposite direction. This will be seen when e.g. removing a headset 10 from the head using a single hand and pulling the sound generator 14 in a direction to the front of the person.

In this situation, the headband 20 will be twisted. Presently, it is preferred that the twisting takes place around the axis 20′within the central part 22, which is possible when the cushioning 30 and the protective element 28 are sufficiently deformable in the desired directions compared to the central part 22.

It is seen that the protective element 28 is made of two small elongate elements following the contour of the central part 22 and being interconnected by a number of wider ribbons. This provides a bendable protective element. This element is able to follow a twisting of the stiffer central part 22 while the wider ribbons secure a space between the wider ribbons and the central part 22 for the carrier assembly 26. This space preferably has a height between the ribbons and the neighbouring surface of the central part 22 is at least 1.3 times a height, along the same direction, of the carrier assembly 26, such a at least 1.5 times, such as at least 2 times, such as at least 2.5 times the height, in order to allow relative movement of the carrier assembly 26 and the central part 22 during twisting.

It is seen, however, that also the space wherein the carrier assembly 26 is provided, is deformed, whereby the carrier assembly 26 may be excessively deformed, if required to deform to the same degree as the central part 22 or the protective element 28. Instead, the carrier assembly is allowed to move within this space as a response to the deformation of the space.

In FIG. 3, a preferred form of the bendable element 24 is illustrated in the shape of a flex print 24 or other bendable element with conducting portions for use with a stiffer carrier component of carrier assembly 26 is illustrated. The flex print 24 has four wide portions 25 interconnected by three narrow portions 25′. The function of the narrow portions 25′ it so act as hinges between the wide portions 25 which are then allowed to remain unaffected, usually flat, by any twisting of the headset and central part 22. Also, bending of the flex print 24 may be allowed.

The bendable element 24 may be a PCB, such as a flex print, onto which the circuits 24′ are soldered or glued. These circuits 24′ may then be positioned on the wide parts 25 so as to not be affected by the twisting. Twisting of a PCB with circuits thereon will easily break some of the soldering bonds and thus render the circuit more or less useless.

Connections may be made via the narrow portions 25 between the circuits 25 or an antenna 24″ which may also be provided on a wide portion. The antenna 24″ may be a Bluetooth antenna or a GPS antenna, for example. In addition or alternatively, sensors, such as accelerometers, magnetometers or the like may be used in order to determine the movement and direction of the user.

In fact, an outer portion 24′″ may act as a back plane for the antenna 24″, when the flex print 24 is folded to position the back plane 24′″ below the antenna 24″ (see the lower part of FIG. 3)

Reverting to FIG. 2, other elements, such as other antennas 22′ may be fixed to other parts of the headset 10, such as the central portion 22, from which signals may be fed to/from the circuits 25 on the bendable element 24 if desired.

In one embodiment, the bendable element has two narrow portions 25′ separated by a wide portion 25 having a portion comprising an antenna and a portion defining a back plane for the antenna, the wide portion being, in operation, bent at a centre thereof to have the antenna overlap the back plane and the two narrow portions 25 overlap.

In one situation, a total length of the bendable element may be 10-20 cm, such as 10-15 mm.

1. A headset comprising:
an elongate central element having two end portions,
one or two sound emitter portions each attached at an end portion of the central element,
a carrier assembly comprising one or more electric circuits and fastened to the central element at a single position thereof.

2. A headset according to clam 1, wherein the central element is arched in a rest position.

3. A headset according to claim 1, wherein the carrier assembly has one or more wide portions divided or interconnected by one or more neck portions.

4. A headset according to claim 3, wherein a first extreme wide portion is positioned closer to one end portion and another side portion closer to another end portion.

5. A headset according to claim 1, the headset further comprising a sensor or detector connected to one or more of the one or more electric circuits.

6. A headset according to claim 5, wherein the sensor or detector is positioned on or fastened to the carrier assembly.

7. A headset according to claim 1, the headset further comprising a protecting element attached to the central element, the protecting element and the central element defining there between a space wherein the carrier assembly is positioned, the protecting element being deformable by twisting the central element around a longitudinal axis of the central element.

8. A headset according to claim 1, wherein the carrier assembly comprises a bendable element to which the one or more electric circuits are fastened and a carrier component, the bendable element being bent to form a U-shape.

9. A headset according to claim 8, wherein an antenna is provided in or on the bendable element, the antenna being positioned on/in a first part of the bendable element forming a first leg of the U-shape and the bendable element comprising, on or in a second part forming a second leg of the U-shape, a conductor forming a ground plane for the antenna.

10. A method of manufacturing a headset, the method comprising:
providing an elongate central element having two end portions,
attaching each of one or two sound emitter portions to an end portion of the central element,
fastening a carrier assembly comprising one or more electric circuits to the central element at a single position thereof.
